(19) United States
(12) Patent Application Publication
(10) Pub. No.: US 2026/0116119 A1
(43) Pub. Date: Apr. 30, 2026

(54) EMBOSSING PLATES AND MOUNTING SYSTEMS FOR MULTI-OPENING PRESSES

(71) Applicant: USNR, LLC, Woodland, WA (US)

(72) Inventors: Clayton M. PARATORE, Painesville, OH (US); Douglas Gerald BRYAN, Andover, OH (US)

(21) Appl. No.: 19/373,271

(22) Filed: Oct. 29, 2025

Related U.S. Application Data
(60) Provisional application No. 63/713,950, filed on Oct. 30, 2024.

(51) Int. Cl. B44B 5/00; B27N 3/02; B27N 3/20; B44C 5/04

(52) U.S. Cl. CPC B44B 5/0052; B27N 3/20; B27N 3/02; B44C 5/043

(57) ABSTRACT

The present disclosure describes methods, systems, and apparatuses for adapting a multi-opening press to produce embossed engineered wood products. An embossing plate is configured to be mounted to the bottom face of a movable plate with fasteners along the longitudinal sides or the bottom face of the movable plate. The movable plate has recesses between the top face and both longitudinal sides. When the press is closed, the fasteners attached to one movable plate are accommodated in the recesses of the next movable plate below. The collective width of the embossing plate and the respective fasteners is less than the distance between the rotational lug paths of conveyors mounted to the longitudinal sides of the movable plate, allowing the conveyors to be driven in a single direction to use the lugs in an alternating manner to move successive caul screens into the press opening.

### CROSS-REFERENCE TO RELATED APPLICATIONS

The present claims the benefit of U.S. Provisional Patent Application Ser. No. 63/713,950 filed Oct. 30, 2024 and titled “EMBOSSING PLATES AND MOUNTING SYSTEMS FOR MULTI-OPENING PRESSES” the entire disclosure of which is hereby incorporated by reference herein.

### BACKGROUND

Oriented strand board (OSB) panels are manufactured by depositing successive layers of oriented wood strands/flakes and resin binder onto a caul screen to form mats, which are then heated and compressed to form the panels. Multi-opening presses with heated plates are commonly used in commercial production facilities to apply the required heat and pressure to the mats.

Multi-opening OSB presses generally include a top platen, a bottom platen, and a stack of vertically movable plates between the top and bottom platens. In most designs the top and bottom platen are stationary, and a movable platen is disposed between the top or bottom platen and the movable plates. The movable plates are connected to a source of heated fluid (e.g., oil, steam, hot water, etc.) that is circulated through them during operation of the press to transfer heat to the mats. Each movable plate has an infeed end, an outfeed end, and opposite longitudinal sides. A conveyor is mounted to each longitudinal side, and the conveyors extend from the infeed end to the outfeed end of the plate. The conveyor typically has a roller chain with two lugs that are positioned at equal distances along its length.

When the press is in an ‘open’ position, the heated plates are vertically spaced apart by the openings between them. Mats on caul screens are moved onto a loader at the infeed end of the press. The loader has a stack of vertically movable platforms/conveyors that are lowered to receive the caul screens and raised to position them at the infeed ends of the movable plates. The leading end of each caul screen has a lateral slat that extends outwardly from both sides of the screen. The movable plate conveyor chains are driven forward to carry the first lug on each chain to the top of the rotational lug path at the infeed end and into engagement with the slats, and along the top of the rotational lug path to the outfeed end, to thereby pull the caul screens into the press openings. The press is then moved to the ‘closed’ position by moving the plates together to close the openings, pressing the plates against the mats or (if the press is empty) one another. A closing system with arms connected to the longitudinal sides of the plates maintains equal vertical spacing between the plates as they are moved toward and away from one another to ensure simultaneous opening and closing.

While the press applies heat and pressure to the mats, the loader receives the next batch of caul screens and mats. Once the press cycle is complete and the press is returned to the open position, the chains of the movable plate conveyors are driven forward again. As the caul screens bearing the pressed panels are pulled in the outfeed direction onto an unloader at the outfeed end of the press, the second lug on the chains engages the lateral slats of caul sheets on the loader and pulls the caul screens into the openings of the press.

### BRIEF DESCRIPTION OF THE DRAWINGS

Embodiments will be readily understood by the following detailed description in conjunction with the accompanying drawings. Embodiments are illustrated by way of example and not by way of limitation in the figures of the accompanying drawings.

FIG. 1 is a partial perspective view of an example of a prior multi-opening press used to manufacture OSB panels, with details of the movable plate assemblies omitted for clarity;

FIG. 2A is a perspective view of a prior movable plate assembly, embossing plate, and mounting system;

FIGS. 2B and 2C are bottom plan and side elevational views, respectively, of the prior movable plate assembly, embossing plate, and mounting system shown in FIG. 2A;

FIG. 2D is a partial end elevational view of the prior movable plate assembly, embossing plate, and mounting system shown in FIGS. 2A-2C; and

FIGS. 3A-3C are schematic diagrams illustrating operation of the conveyors of a prior movable plate assembly (FIG. 3A) and the prior movable plate assembly fitted with a prior embossing plate, all according to prior methods and designs (FIGS. 3B, 3C).

FIG. 4 is a perspective view of movable plate assemblies, embossing plates, and mounting systems;

FIG. 5 is a side elevational view of the movable plate assemblies, embossing plates, and mounting systems shown in FIG. 4;

FIG. 6A is a sectional view taken along line A-A of FIG. 5;

FIG. 6B is a sectional view taken along line B-B of FIG. 5;

FIG. 6C shows the sectional view of FIG. 6B with the movable plate assemblies in a closed position;

FIGS. 7A and 7B are end elevational views of movable plates;

FIG. 8 is an end elevational view of a movable plate assembly, embossing plate, and mounting system;

FIG. 9A is a schematic view of the underside of a movable plate assembly, embossing plate, and mounting system;

FIG. 9B is a sectional view taken along lines A-A of FIG. 9A;

FIG. 10A is a schematic view of the underside of another movable plate assembly, embossing plate, and mounting system; and

FIG. 10B is a sectional view taken along lines A-A of FIG. 10A, all in accordance with embodiments of the present disclosure.

### DETAILED DESCRIPTION OF DISCLOSED EMBODIMENTS

In the following detailed description, reference is made to the accompanying drawings which form a part hereof and show by way of illustration embodiments that may be practiced. It is to be understood that other embodiments may be utilized, and structural or logical changes may be made, without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other but cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A) B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous.

The present disclosure provides embodiments of systems, methods, and apparatuses for producing embossed wood composite products with a multi-opening press.

As used herein, a “multi-opening press” is a press that has a top platen, a bottom platen, movable plates disposed between the top platen and the bottom platen and configured to receive heat from a heat source, and pairs of conveyors that are mounted to the longitudinal sides of the respective movable plates and configured to circulate respective lugs along respective rotational lug paths that extend from an infeed end of the press to an outfeed end of the press.

As used herein, “wood composite” refers to materials that include fibers, strands, chips, shavings, flakes, dust, and/or particles of wood or cellulose and an adhesive or binder (e.g., resin, plastic, plastic polymer, cement, etc.). Examples include, but are not limited to, fiberboard, wood-plastic composites, and wood-cement composites.

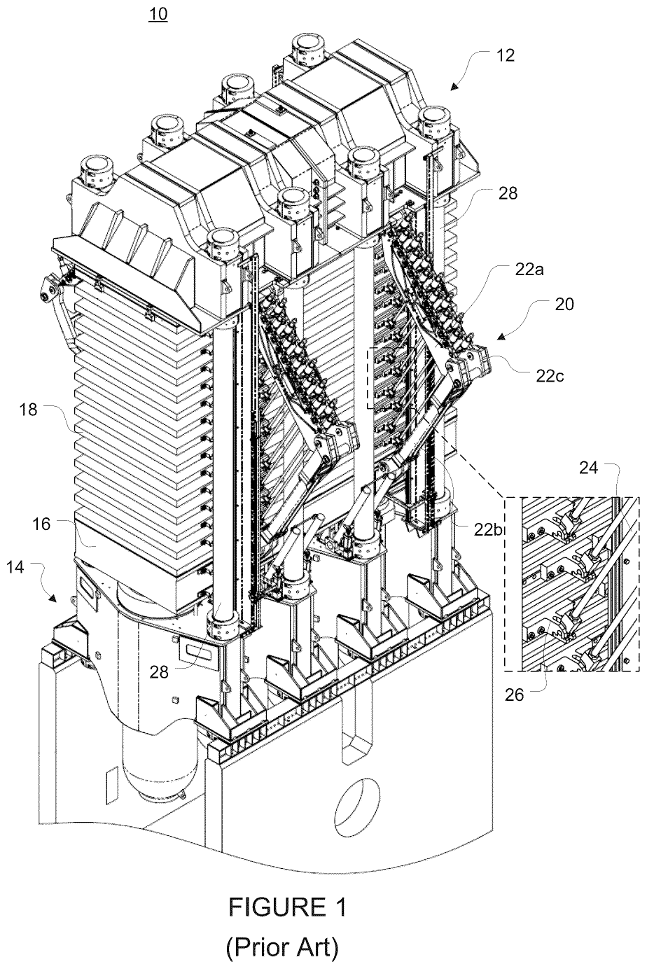

An example of a multi-opening press 10 designed for manufacturing OSB panels is shown by way of reference in FIG. 1. The multi-opening press 10 includes a top platen 12, a bottom platen 14, a movable platen 16 between the top and bottom platens 12 and 14, and two or more vertically movable plates 18 between the top platen 12 and the movable platen 16. The multi-opening press 10 also has a closing system 20 that is configured to maintain consistent spacing between the movable plates 18 as the press 10 opens and closes. The closing system has two pairs of articulated arms 22 positioned on opposite sides of the press and connected to the movable plates 18 by respective rods 24 and brackets 26. Each articulated arm 22 has an upper portion 22a and a lower portion 22b that are connected by a hinge 22c. Each movable plate 18 is provided with four brackets 26 (two along each of the longitudinal sides). A first end of each rod 24 is connected to the upper portion 22a of one of the articulated arms 22, and an opposite second end of the rod 24 is pivotably connected to a respective one of the brackets 26. Thus, each movable plate 18 is connected to each of the articulated arms 22 by corresponding rods 24, one pair on each side. This arrangement maintains consistent spacing between the movable plates as the movable platen is moved vertically downward and upward to open and close the press, such that the openings between the plates close simultaneously and open simultaneously. A heated fluid or gas, such as oil or steam, is supplied to and circulated through the movable plates. While the temperature of the heated fluid/gas varies, a temperature of approximately 450° F. is typical.

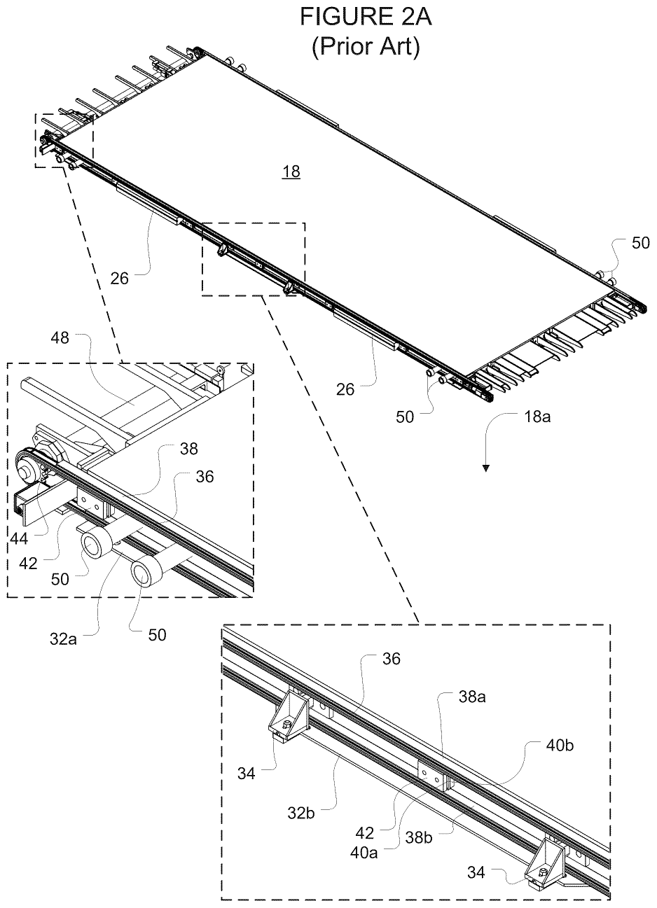

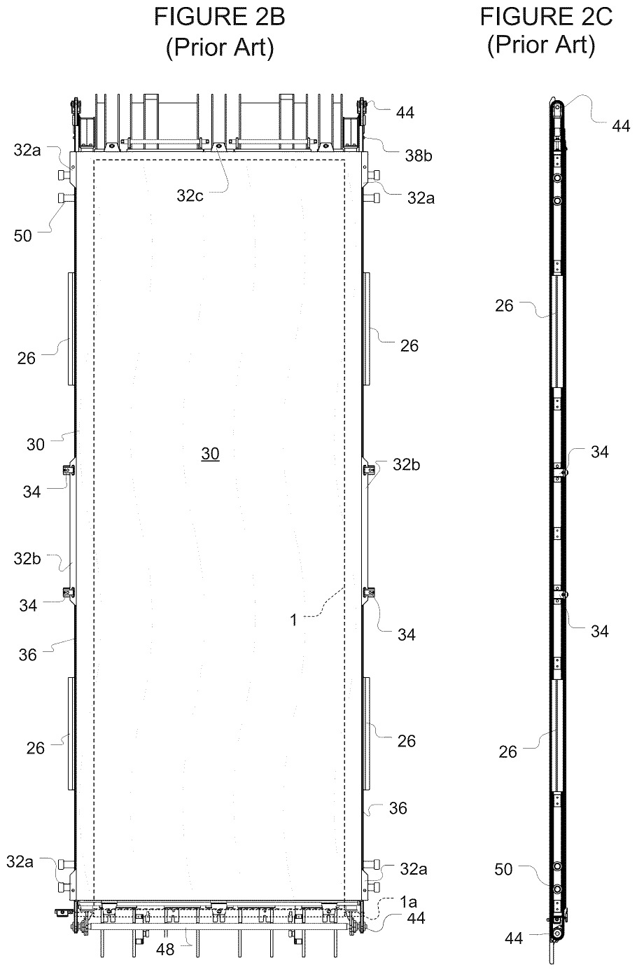

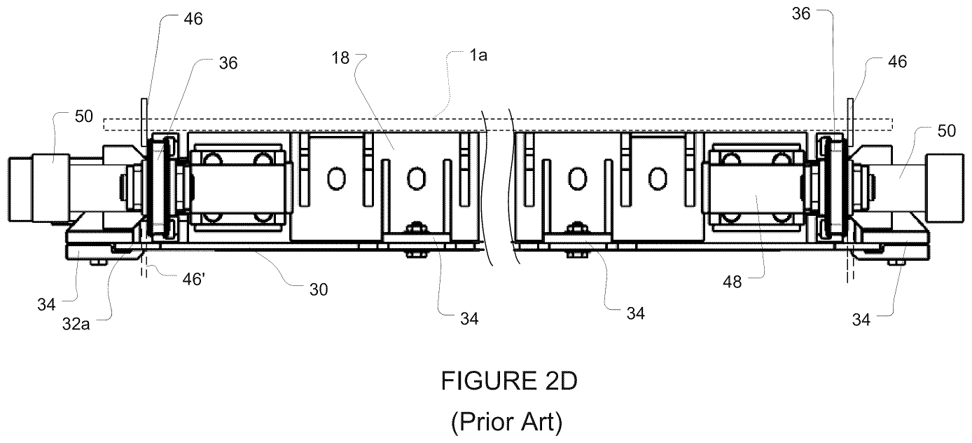

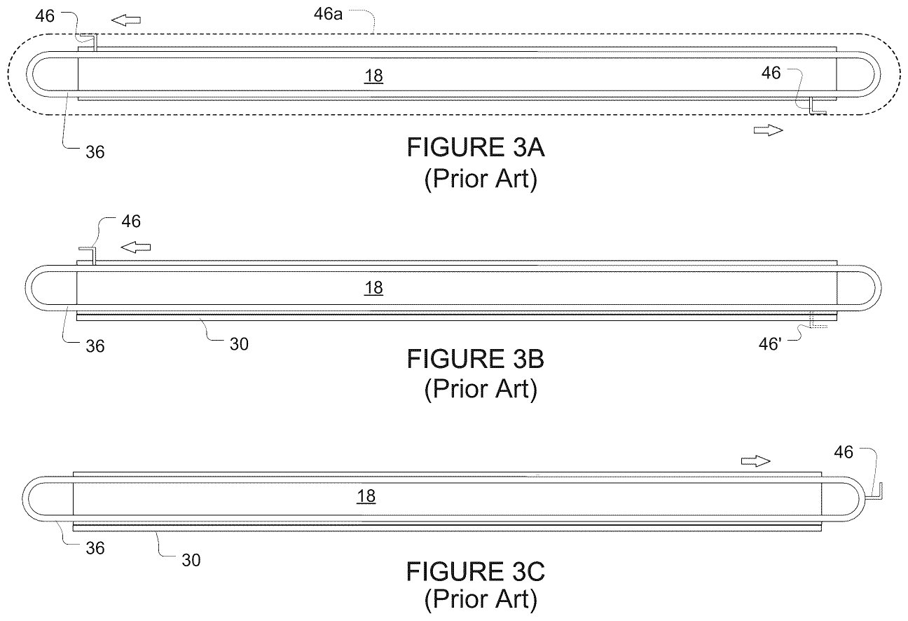

Columns 28 support the upper platen 12 and other components, and in some cases, are used as guide surfaces to guide the vertical movement of movable plates 18 and/or movable platen 16. Conveyors are mounted to each longitudinal side of the movable plates (see e.g., FIG. 2A). Each conveyor has a chain (typically a roller chain) with two lugs that are positioned at equal distances along its length (see FIG. 3A). The chains are driven in the forward direction toward the outfeed end to bring a lug on each chain into engagement with the lateral slat 1a of the caul screen 1 (shown in phantom in FIGS. 2B, 2D) and to pull the caul screen 1 into the press. The press is moved to the closed position to bring the heated movable plates into contact with the mats. The movable plates transfer pressing force from the moving platen and heat from the fluid or gas to the mats. After the mat has been formed into a panel, the press is moved to the open position and the chains are driven forward to bring the other set of lugs into contact with the next caul screen to thereby pull it into the press opening.

Recently, some production facilities have begun to use multi-opening OSB presses to make sheathing, siding, or other wood composite products with a desired three-dimensional (3D) surface pattern. To adapt the presses for such use, the presses were fitted with embossing plates. The embossing plates, which are usually made from sheet metal, have a front side (the side that will contact the mat) and a back side. The front side has a 3D surface contour that is complementary, or inverse, to the desired 3D surface pattern. The embossing plates were secured to the undersides of the movable plates, and to the underside of the uppermost stationary heated plate (if any). Closing the press forced each embossing plate onto the top of the mat below it to form the desired 3D surface pattern on the mat as it was being heated and pressed into a panel. In the prior designs, the embossing plates (and/or the means used to attach them to the movable plates) extended into the path of the conveyor lugs, interfering with the operation of the conveyors.

FIGS. 2A-2D illustrate an example of a prior movable plate 18 fitted with a prior embossing plate 30 according to prior methods. As illustrated, each of the two conveyors mounted to the longitudinal sides of the movable plate has an endless chain 36 (e.g., a roller chain) and a chain guide 38. Chain guide 38 is configured to guide chain 36 along a path of rotation that extends at least from the input end of the movable plate to the output end of movable plate 18. In the illustrated design, chain guide 38 has an upper rail 38a and a lower rail 38b. Each rail forms a channel that is open along the outer side (the side facing away from the movable plate) of the rail, allowing the two lugs 46 mounted to the chain 36 to travel along a rotational lug path 46a alongside the rails (see e.g., FIG. 2D, 3A).

Tabs 40 with respective openings are welded or otherwise attached to the rails, with tabs 40a extending downwardly from upper rail 38a and tabs 40b extending upwardly from lower rail 38b. Each tab 40a of the upper rail is positioned to align with, and overlap, a corresponding tab 40b of the lower rail with the respective openings in alignment with corresponding openings along the longitudinal side of the movable plate. Each pair of tabs 40a, 40b is sandwiched between a pair of spacers 42 (e.g., bars or plates) with respective openings to position the rails at a desired offset from the longitudinal side of the movable plate. This typically leaves a gap between the longitudinal side of the movable plate and the inner sides of the rails (the sides facing the movable plate). The rails are mounted to the movable plate by aligning the upper and lower rails and inserting bolts or other suitable fasteners through the holes in the tabs and spacers and into corresponding holes in the movable plate.

Chain 36 is engaged by sprockets 44 located at opposite ends of the path of rotation. At one end (the outfeed end or the infeed end), the sprockets 44 are connected to a shaft 48, which is driven by a motor or other means to thereby drive the chains 36 of both conveyors.

Embossing plate 30 is supported in place against the underside of movable plate 18 by clamps 34, which are attached to the longitudinal sides of the movable plate. Clamps 34 extend outwardly between, and beyond the exterior sides of, the upper and lower rails 38a and 38b. Embossing plate 30 has side extensions 32a near its upstream and downstream ends, and side extensions 32b along a middle portion of its length, each with one or more holes or slots positioned for engagement with the respective clamp(s) 34. Embossing plate 30 also includes end extensions 32c at the upstream and/or downstream ends to engage additional clamps 34 attached to the lateral sides of the movable plate.

As best shown in FIG. 2D, the side extensions 32a and 32b and the clamps 34 are within the rotational path of the lugs 46. While one lug 46 can travel along the upper portion of the rotational path, the side extensions and the clamps extend into the bottom portion of the rotational path, preventing passage of the second lug (shown in phantom as 46′). For that reason, in the prior designs each of the chains 36 can have only one lug 46. The other lug 46 must be removed.

In addition to removing the second lug, prior designs require the conveyors to be operated in a different manner. Referring now to FIG. 3A, in a multi-opening press used to manufacture OSB the chains 36 are driven in one direction (forward), and the two equally spaced lugs 46 are used in an alternating manner to pull successive caul screens into the press. As one of the lugs travels along the top of the rotational path from an engaging position near the infeed end to a disengaging position near the outfeed end, the other lug travels along the bottom of the rotational path from the disengaging position to the engaging position, where it is ready to engage the next caul screen. After the press is fitted with prior embossing plates 30 according to the prior methods and designs, and the second lug is removed (see FIG. 3B, shown in phantom as 46′), the chain must be driven in the forward direction to bring the remaining lug from the engaging position to the disengaging position, and driven in the reverse direction to return the remaining lug from the disengaging position to the engaging position where it can engage the next successive caul screen. Reversing the chains each press cycle to return the lugs to the engaging position reduces production speed and through-put through the press.

The present disclosure provides embodiments of systems, methods, and apparatuses for producing embossed wood composite products. In particular, the present disclosure provides embodiments of movable plates, embossing plates and mounting systems, and movable plate assemblies in which the embossing plate and mounting features are configured to permit normal operation of the conveyors without the removal of a lug or reversal of the conveyors after a press cycle. The present disclosure also provides multi-opening presses that include any or all of the foregoing, as well as related kits, methods, and systems.

In various embodiments, a movable plate has a first face and an opposite second face, a first longitudinal side and an opposite second longitudinal side that are transverse to said faces, a first recess that extends from the first face to the first longitudinal side, and a second recess that extends from the first face to the second longitudinal side. The width of the first face between the recesses is less than a width of the second face between the longitudinal sides, and a height of the longitudinal sides from the second face to the respective recesses is less than a distance between the second face and the first face. The movable plate is configured to receive heat from a heat source (e.g., in the form of a heated fluid).

In some embodiments, the first recess has a first surface that intersects the first face and extends transverse thereto, and a second surface that is transverse to the first surface and the first longitudinal side. For example, the first surface may be perpendicular to the first face and/or parallel to the longitudinal sides, and the second surface may extend at an angle α relative to the first face, and the angle α is within the range of 20-40 degrees, and preferably within the range of 25-35 degrees. Alternatively, the first surface may be perpendicular to the first face and/or parallel to the longitudinal sides, and the second surface may be perpendicular to the longitudinal sides and/or parallel to the first face. In other embodiments, the first recess may have a first surface that is flat or curved in profile and extends from the first face to the first longitudinal side. Preferably the first face is the top face of the movable plate, and the second face is the bottom face of the movable plate.

The movable plate may optionally include a plurality of openings. The openings may be in the second face of the movable plate, proximal to the longitudinal edges and/or in vertical alignment with the recesses. Alternatively, or in addition, the movable plate may have a plurality of openings in, and spaced apart along, the longitudinal sides of the movable plate. In that case, the openings may optionally be equidistant between the upper face and the lower face. In some embodiments, the movable plate includes openings located in the second face of the movable plate and in vertical alignment with the recesses, and additional openings in the longitudinal sides of the movable plate.

In various embodiments, a movable plate assembly includes the movable plate, a first conveyor mounted to the first longitudinal side of the movable plate, and a second conveyor mounted to the second longitudinal side of the movable plate. Each conveyor includes a chain guide mounted to the respective longitudinal side of the movable plate, an endless chain rotatably mounted to the chain guide, and a first lug and a second lug mounted to an outer side of the endless chain at equal distances along the endless chain. The endless chains of the first and second conveyors are rotatable to thereby move the lugs along respective first and second rotational lug paths. Optionally the chain guide may include an upper chain rail and a lower chain rail, each with respective mounting means. As an example, the mounting means may include tabs that extend outwardly from the chain rails, parallel to the rotational lug paths, and are configured to be mounted to a corresponding one of the longitudinal sides with respective fasteners (e.g., bolts or screws). In such embodiments the tabs of the upper chain rail may be arranged to overlap corresponding tabs of the lower chain rail such that first apertures extending through respective pairs of the tabs are in axial alignment with corresponding second apertures in the longitudinal sides of the movable plate. Optionally the movable plate assembly may further include a plurality of first spacers configured to be mounted to the movable plate between a respective one of the longitudinal sides and a respective pair of the tabs, and the first spacers may have third apertures arranged to be in axial alignment with the respective ones of the first and second apertures.

In various embodiments, an embossing plate assembly configured for use with movable plates and movable plate assemblies as described herein includes an embossing plate and a mounting system. The mounting system includes a plurality of fasteners configured to mount the embossing plate to the movable plate. The embossing plate assembly has a maximum width, when mounted to the movable plate assembly, that is less than the distance between the rotational lug paths of the conveyors. Optionally the embossing plate assembly may further include the movable plate.

In various embodiments, the embossing plate has a back side, an opposite front side, a pair of longitudinal edges, a pair of lateral edges, a plurality of through-holes that extend through the sides proximal to the longitudinal edges, and a maximum width that is less than the distance between the rotational lug paths of the conveyors. Optionally the maximum width of the embossing plate may be less than, or equal to, the distance between an inner side of the first chain guide and an inner side of the second chain guide, or less than or equal to the width of the bottom face of the movable plate. Optionally the longitudinal edges and the lateral edges of the embossing plate are linear and coplanar, and the longitudinal edges are perpendicular to the lateral edges, such that the embossing plate has a constant width along its length and a constant length along its width. The front side of the embossing plate may have a 3D surface pattern that corresponds to a desired 3D surface pattern to be formed on the surface of a workpiece; however, this is not essential.

In some embodiments, the fasteners are configured to be inserted through the through-holes into corresponding openings in the bottom face of the movable plate. In such embodiments, the first and second recesses are along the top face of the movable plate, and the openings are in vertical alignment with the recesses. In these embodiments the first fasteners may be bolts or screws.

In other embodiments, the fasteners include first fasteners that are configured to be mounted to the longitudinal sides of the movable plate and to extend from the longitudinal sides to the through-holes in the embossing plate. In some of these embodiments the first fasteners have a first portion with a first terminal end, a second portion with a second terminal end, and a middle portion between the first and second portions. The through-holes of the embossing plate are configured to receive the second terminal ends, and the first portions of the fasteners have first mounting features arranged to align with complementary second mounting features along the respective longitudinal sides of the movable plate. When mounted to the movable plate assembly, the first portion of the fastener is preferably located between the respective longitudinal side of the movable plate and the respective conveyor. Optionally the first mounting features are holes or slots, and the second mounting features are openings along the longitudinal sides of the movable plate. In that case, the embossing plate can be mounted to the movable plate by inserting the second ends of the fasteners into the respective through-holes of the embossing plate, aligning the holes or slots of the first fasteners with the respective openings in the movable plate, and inserting second fasteners (e.g., bolts, screws, or the like) through the aligned mounting features. As an example, the first fasteners may be clips, hooks, or brackets that are J-shaped in profile, with holes or slots in the first portion. Preferably the first and middle portions are flat and meet at an angle.

In still other embodiments, the first fasteners may be clips, hooks, or brackets that are L-shaped in profile, with mounting features (e.g., holes or slots) at each of the terminal ends, and the embossing plate can be mounted to the movable plate by inserting second fasteners (e.g., bolts, screws, or the like) through the holes or slots and into corresponding openings along the longitudinal sides and bottom face of the movable plate.

In various embodiments, a kit for modifying a multi-opening press to produce embossed wood composite items may include a movable plate and an embossing plate as described herein. Optionally, the kit may further include a plurality of first fasteners as described herein. In that case, the kit may also optionally include a plurality of second fasteners configured to mount the first fasteners to the movable plate.

In various embodiments, a method of adapting a movable plate (or a movable plate assembly) for use with an embossing plate may include forming a first recess and a second recess along the movable plate, such that the first recess extends from the first face to the first longitudinal side, the second recess extends from the first face to the second longitudinal side, and the width of the top face between the recesses is less than a width of the bottom face between the longitudinal sides and/or a height of the longitudinal sides from the bottom face to the respective recesses is less than a height of the movable plate between the recesses. Optionally the method may further include forming a plurality of openings along the longitudinal sides and/or the bottom face of the movable plate. Optionally the method may further include mounting the embossing plate to the movable plate with a plurality of fasteners.

In various embodiments, a method of adapting or modifying a multi-opening press to manufacture embossed wood composite products may include providing the press with a plurality of movable plate assemblies as described herein. Optionally the method may further include mounting an embossing plate assembly as described herein to at least one of the movable plate assemblies.

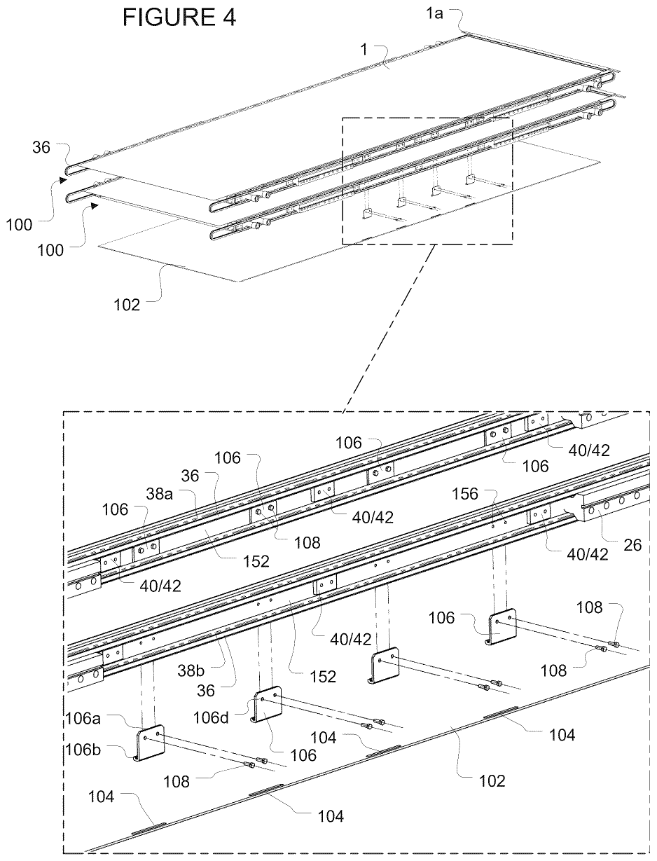

Embodiments of a movable plate assembly and an embossing plate assembly are illustrated by way of example in FIGS. 4-6C.

Movable plate assembly 100 includes a movable plate 152 and a pair of conveyors mounted to respective longitudinal sides of the movable plate 152. Movable plate 152 is described further below.

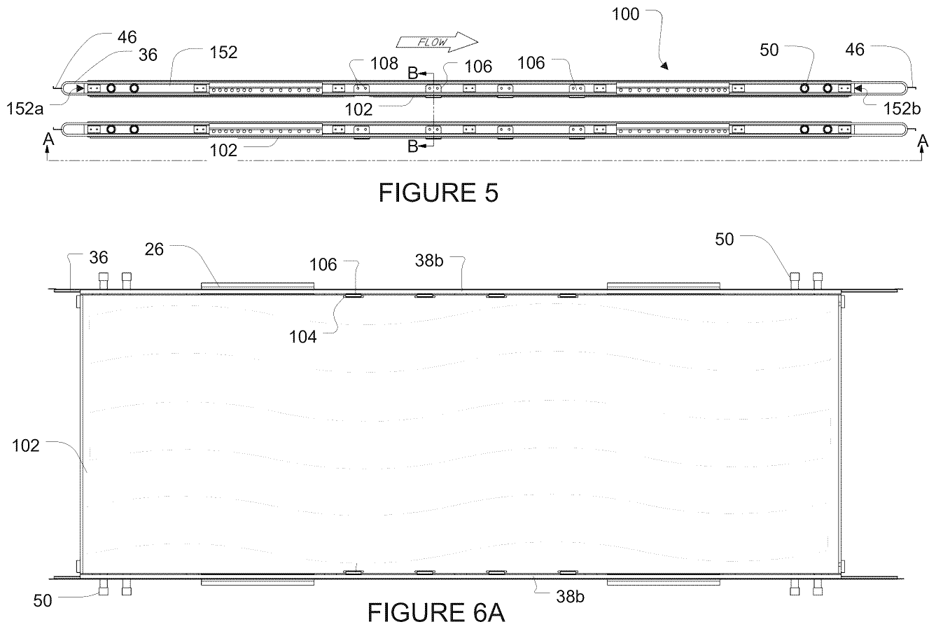

The conveyors, their components, and the items and methods used to mount them to the movable plate are as described above with reference to FIGS. 2A-2D. Again, each of the conveyors includes a chain guide 38 mounted to a respective one of the longitudinal sides, an endless chain 36 rotatably mounted to the chain guide 38, and two lugs 46 mounted to the endless chain 36 at equal distances along the endless chain. The chain guides 38 are mounted to respective longitudinal sides of the movable plate 152, and the endless chains 36 are rotatable to thereby move the respective lugs 46 along corresponding rotational lug paths. Chain guide 38 is configured to guide chain 36 along a path of rotation that extends at least from an input end 152a of movable plate 152 to an output end 152b of movable plate 152 (see FIG. 5). Optionally, chain guide 38 may include an upper rail 38a and a lower rail 38b, each forming a channel that is open along the outer side thereof to allow the respective pair of lugs 46 to travel along a respective rotational lug path. The chain guides 38 (or upper rails 38a and lower rails 38b) can be mounted to movable plate 152 in any suitable manner. For example, they may have tabs 40 and spacers 42, each with respective openings, as in prior designs. Chain 36 is engaged by sprockets 44 located at opposite ends of the path of rotation. At one end (the outfeed end or the infeed end), the sprockets 44 are connected to a shaft 48, which is driven by a motor or other means to thereby drive the chains 36 of both conveyors.

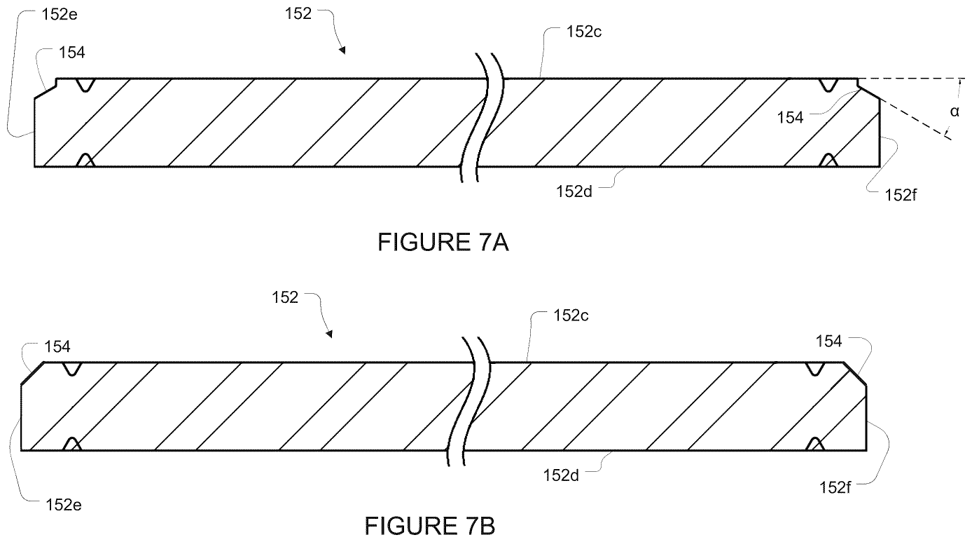

Movable plate 152 has a top face 152c and an opposite bottom face 152d, a first end (input end) 152a and an opposite second end (output end) 152b that are transverse to said faces, and a first longitudinal side 152e and an opposite second longitudinal side 152f that are transverse to said faces and said ends (see e.g., FIGS. 5 and 7). A fluid passage 50 is disposed through at least one of the longitudinal sides. In contrast to prior movable plates, movable plate 152 has a first recess 154 that extends from the top face 152c to the first longitudinal side 152e, and a second recess 154 that extends from the top face 152c to the second longitudinal side 152f, such that a width of the top face 152c between the recesses 154 is less than a width of the bottom face 152d between the longitudinal sides 152e and 152f. Movable plate 154 is configured to receive a heated fluid through the fluid passage 50.

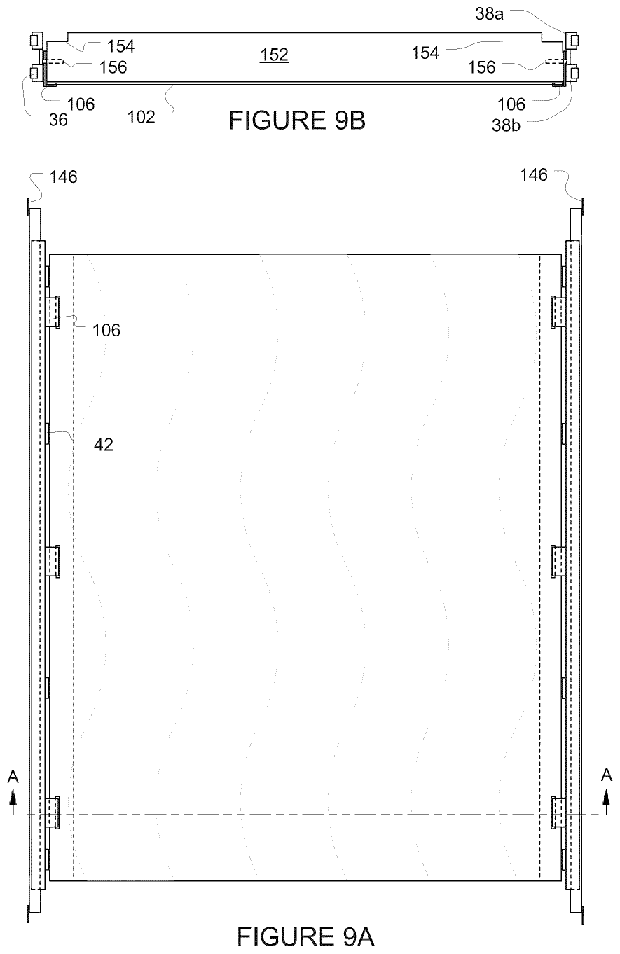

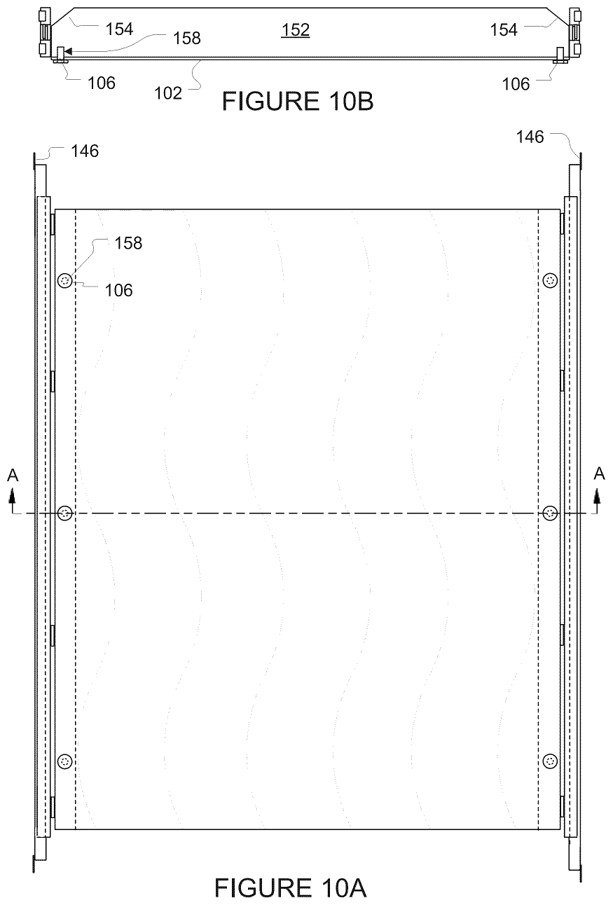

Optionally, movable plate 152 may include a plurality of openings 158 along the bottom face 152d and/or a plurality of openings 156 along the longitudinal sides 152e and 152f. Openings 158, if present, are preferably arranged proximal to the longitudinal sides and/or in vertical alignment with the recesses 154 (see e.g. FIGS. 10A-10B). Openings 156, if present, are preferably spaced apart and arranged to avoid overlap between fasteners 106 and other components attached to movable plate 152 (see e.g., FIGS. 4 and 9B). In some embodiments, movable plate 152 has openings 158 in the bottom face and openings 156 in the longitudinal sides.

Referring again to FIGS. 4-6C, embodiments of an embossing plate assembly include an embossing plate 102 and a plurality of first fasteners 106. Embossing plate 102 has a back side and an opposite front side, a pair of longitudinal edges, and a plurality of through-holes 104 that extend through the sides. Through-holes 104 may be located proximal to the longitudinal edges. Preferably through-holes 104 are configured to receive a corresponding part of first fasteners 106.

In some embodiments, first fasteners 106 are bolts, screws, or other such fasteners that are inserted through the through-holes 104 and the bottom face of the movable plate. In other embodiments, first fasteners 106 are clips or brackets that are angled in cross-section.

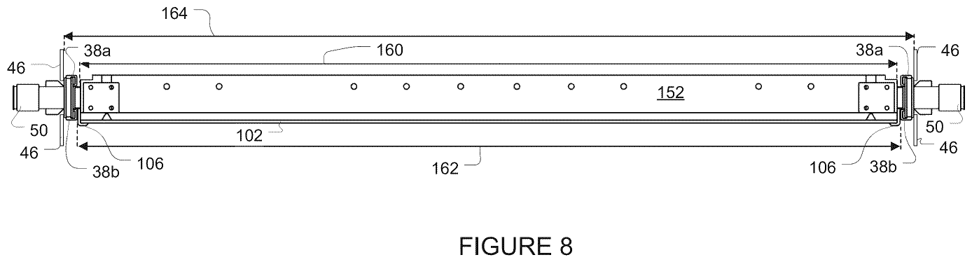

Embossing plate 102 preferably has a maximum width that is less than a distance 164 (FIG. 8) between the rotational lug paths of the conveyors. The maximum width of the embossing plate may also be less than, or equal to, the distance 162 between the inner sides of the two chain guides 38. In other embodiments the maximum width of the embossing plate is less than or equal to the width 160 of the bottom face of the movable plate. Optionally, the longitudinal edges and the lateral edges of the embossing plate are linear and coplanar, with the longitudinal edges perpendicular to the lateral edges, such that the embossing plate has a constant width along its length and a constant length along its width. Typically the front side of the embossing plate has a 3D surface pattern that corresponds to a desired 3D surface pattern to be formed along a surface of a workpiece, but this is not essential.

Similarly, when the embossing plate assembly is mounted to the movable plate assembly, the embossing plate assembly has a maximum width that is less than the distance 164 between the rotational lug paths of the conveyors. Optionally, the maximum width of the embossing plate assembly is less than, or equal to, the distance between the inner sides of the two chain guides 38.

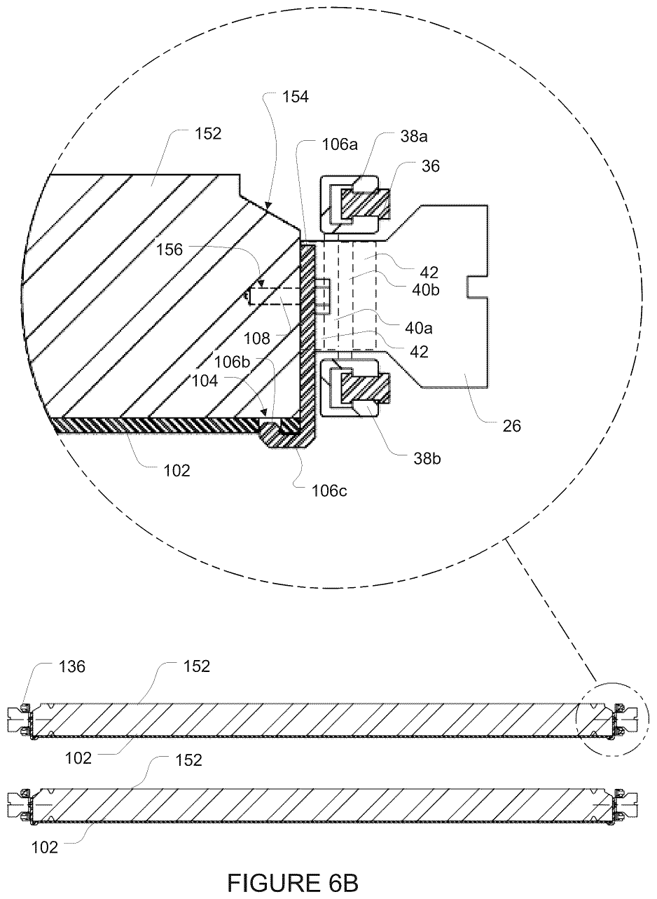

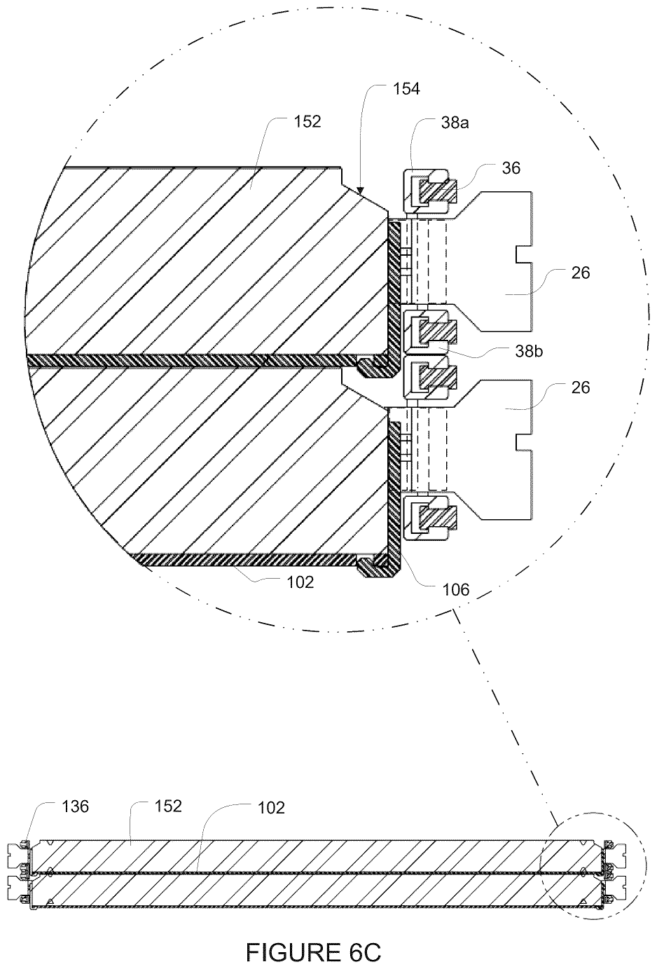

The recesses 154 of movable plate 152 accommodate the downwardly protruding portion(s) of the fasteners 106 that are mounted to the next movable plate above, allowing the movable plate assemblies 100 with respective embossing plates to be moved into contact with one another when the press is moved to the closed position (see e.g., FIG. 6C). Thus, the shape and dimensions of recesses 154 vary among embodiments. For example, in some embodiments recess 154 has a first surface that intersects the top face 152c and extends transverse thereto, and a second surface that is transverse to the first surface and the respective longitudinal side (see e.g., FIG. 7A). In that case, the first surface may be perpendicular to the first face and/or parallel to the longitudinal sides, and the second surface may extend at an angle α relative to the first face. In the example shown in FIG. 7A, the angle α is approximately 30 degrees; however, the angle α can be within the range of 20-40 degrees or within the range of 25-35 degrees. Alternatively, the first surface may be perpendicular to the first face and/or parallel to the longitudinal sides, and the second surface may be perpendicular to the longitudinal sides and/or parallel to the first face (see e.g., FIG. 9B). Alternatively, recess 154 can have a flat or curved surface that joins, and is transverse to, the top face 152c and the respective longitudinal side (see e.g., FIGS. 7B and 10B). In some embodiments the recesses 154 extend continuously from the input end 152a to the output end 152b. In other embodiments the recesses may extend less than the entire length of the movable plate. In still other embodiments, the recesses 154 may be discontinuous. For example, each of the recesses 154 may be a plurality of recesses that are spaced apart along the respective longitudinal side. These are merely examples, and recesses 154 can have any shape and dimensions suitable to accommodate fasteners 106.

In a preferred embodiment, the fasteners 106 are clips, hooks, or brackets that are J-shaped in profile (see e.g., FIGS. 4-6B and 8-9B). The fasteners have a first portion 106a with a first terminal end, a second portion 106b with a second terminal end, and a third portion 106c that extends from the first portion 106a to the second portion 106b (see e.g., FIG. 6B). The first portions 106a are provided with mounting features 106d (e.g., holes or slots; see FIG. 4). Each of the first, second, and third portions is substantially flat, with the first and second portions extending transverse to the third portion. The through-holes 104 of the embossing plate are dimensioned to receive the second ends 106b of the fasteners. The embossing plate is mounted to the movable plate 152 by inserting the second ends 106b of the fasteners 106 into the through-holes 104 and mounting the first portions 106a of the fasteners 106 to the movable plate by inserting second fasteners 108 (e.g., bolts or screws) through the mounting features 106d and into respective openings 156 along the longitudinal sides of the movable plate 152. When mounted to the movable plate assembly, the first portion 106a is located between the respective longitudinal side of the movable plate and the respective conveyor.

In another embodiment, the fasteners 106 are bolts, screws, or the like (see e.g., FIGS. 10A-10B). The embossing plate 102 can be mounted to the movable plate 152 by inserting the fasteners 106 through the through-holes 104 of the embossing plate and into openings 158 in the bottom face of the movable plate.

In either case, the recesses along the top face of the movable plate accommodate the bottom-most portions of the fasteners mounted to the next movable plate above, allowing the movable plates (or the respective movable plate assemblies) to be moved vertically into contact with one another.

A multi-opening press can be adapted for use to manufacture embossed wood composite products by providing the press with one or more movable plates and/or movable plate assemblies, and optionally with one or more embossing plate assemblies, as described herein. For example, an existing/prior movable plate of the press can be replaced with a movable plate as described herein, or modified by machining or other means to form recesses (e.g., recesses 154) that extend from the top face to the respective longitudinal sides (and optionally to form openings along the longitudinal sides and/or bottom face) to thereby form a movable plate as described herein. Conveyors and/or other components that were mounted to the existing/prior movable plate can optionally be mounted to the new or modified movable plate to form a movable plate assembly as described herein. Reusing such components may reduce the cost of adapting the press. Alternatively, an existing/prior movable plate assembly of the press can be replaced with a movable plate assembly as described herein. In any case, an embossing plate assembly as described herein may optionally be mounted to the movable plate or movable plate assembly. This method may be performed to replace one or more, or all, of the existing/prior movable plates (or existing/prior movable plate assemblies) of the press.

When a multi-opening press is fitted with embossing plates, it is generally preferable to have an embossing plate in each press opening (particularly if the press is equipped with a closing system). This helps to prevent variations in opening heights and uneven closing of the press openings. For the same reason, it is generally preferable for each of the movable plates to have a first thickness, and for each of the embossing plates to have a second thickness. To allow the press to be operated with a combination of new movable plates (and new embossing plates) and prior movable plates (and prior embossing plates), embodiments of movable plates and embossing plates described herein may optionally have the same thicknesses as the prior movable plates and embossing plates, respectively. This enables replacement of the prior movable plates (or movable plate assemblies) in a staggered manner, in groups of one or more, at different times or during different maintenance/shut-down periods.

Embodiments of the present disclosure enable movable plate assemblies to be fitted with embossing plates in a manner that does not interfere with the operation of the conveyors, allowing the conveyors to rotate fully in the forward direction. This may result in improved cycle times and increased throughput through the multi-opening press. The movable plates, movable plate assemblies, and embossing plate assemblies disclosed herein allow existing/older multi-opening presses to be fitted with embossing plates. Moreover, the embossing plate assemblies allow the embossing plates to be removed for cleaning and replaced as necessary.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

What is claimed is:

1. A movable plate for a multi-opening press, the movable plate comprising:
a top face and an opposite bottom face;
a first end and an opposite second end that are transverse to said faces;
a first longitudinal side and an opposite second longitudinal side that are transverse to said faces and said ends;
a fluid passage disposed through at least one of the longitudinal sides; and
a first recess that extends from the top face to the first longitudinal side, and a second recess that extends from the top face to the second longitudinal side, such that a width of the top face between the recesses is less than a width of the bottom face between the longitudinal sides.

2. The movable plate of claim 1, wherein the first recess has a first surface that intersects the top face and extends transverse thereto, and a second surface that is transverse to the first surface and the first longitudinal side.

3. The movable plate of claim 1, wherein the first recess is a flat or curved surface that joins, and is transverse to, the top face and the first longitudinal side.

4. The movable plate of claim 1, further including a plurality of openings that extend through the bottom face of the movable plate, wherein the openings are located proximal to respective longitudinal edges of the bottom face and/or in vertical alignment with the recesses.

5. The movable plate of claim 1, further including a plurality of openings in the longitudinal sides of the movable plate, wherein the openings are spaced apart along the longitudinal sides.

6. The movable plate of claim 1, further including a first plurality of openings that extend through the bottom face of the movable plate, proximal to the longitudinal sides and/or in vertical alignment with the recesses, and a second plurality of openings in the longitudinal sides of the movable plate.

7. A movable plate assembly comprising:
a movable plate as recited in claim 1;
a first conveyor mounted to the first longitudinal side of the movable plate; and
a second conveyor mounted to the second longitudinal side of the movable plate,
wherein each of the conveyors includes a chain guide mounted to a respective one of the longitudinal sides, an endless chain rotatably mounted to the chain guide, and a first lug and a second lug mounted to the endless chain at equal distances along the endless chain, and each of the endless chains is rotatable to thereby move the respective ones of the lugs along a corresponding rotational lug path.

8. The movable plate assembly of claim 7, further including:
an embossing plate assembly mounted to the movable plate, wherein the embossing plate assembly includes
an embossing plate disposed along the bottom face of the movable plate, wherein the embossing plate has opposite faces joined by opposite longitudinal edges, and a plurality of through-holes arranged in vertical alignment with the recesses of the movable plate, and
a plurality of first fasteners connecting the embossing plate to the movable plate,
wherein the embossing plate and the first fasteners are between the rotational lug paths.

9. The movable plate assembly of claim 8, wherein the embossing plate has a width that is equal to, or less than, a width of the bottom face of the movable plate.

10. The movable plate assembly of claim 8, wherein the first fasteners have a first end and a second end, each of the first ends is disposed between the movable plate and a respective one of the conveyors, and each of the second ends is received within a respective one of the through-holes.

11. The movable plate assembly of claim 8, wherein the first fasteners are disposed through respective ones of the through-holes and the bottom face of the movable plate.

12. An embossing plate assembly for use with a movable plate assembly of a multi-opening press, wherein the movable plate assembly includes a movable plate and a pair of conveyors mounted to respective longitudinal sides of the movable plate, and each of the conveyors defines a corresponding rotational lug path, the embossing plate assembly comprising:
an embossing plate having a back side and an opposite front side, a pair of longitudinal edges, and a plurality of through-holes that extend through the sides and are located proximal to the longitudinal edges; and
a plurality of first fasteners configured to mount the embossing plate to a bottom face of the movable plate, such that a collective width of the embossing plate and the first fasteners is less than a distance between the rotational lug paths of the conveyors.

13. The embossing plate assembly of claim 12, wherein the first fasteners are J-shaped in profile.

14. The embossing plate assembly of claim 12, wherein the first fasteners are bolts or screws.

15. A multi-opening press comprising a movable plate as recited in claim 1.

16. A multi-opening press comprising an embossing plate assembly as recited in claim 12.

17. A method of modifying a movable plate for a multi-opening press, wherein the movable plate has a top face and an opposite bottom face, a first end and an opposite second end that are transverse to said faces, a first longitudinal side and an opposite second longitudinal side that are transverse to said faces and said ends, and a fluid passage disposed through at least one of the longitudinal sides, the method comprising:
forming a first recess that extends from the top face to the first longitudinal side, and a second recess that extends from the top face to the second longitudinal side, such that a width of the top face between the recesses is less than a width of the bottom face between the longitudinal sides.

18. The method of claim 17, wherein the first recess extends from the first end to the second end.

19. A multi-opening press system for producing embossed wood composite panels, the multi-opening press system comprising:
a first movable plate assembly having a first movable plate and a first pair of conveyors;
a second movable plate assembly having a second movable plate and a second pair of conveyors, wherein each of said movable plates has a top face and an opposite bottom face, a first and an opposite second longitudinal side, and a first and a second recess that extend from the first and second longitudinal sides, respectively, to the top face, such that a width of the top face between the recesses is less than a width of the bottom face between the longitudinal sides; and
an embossing plate mounted to the first movable plate by a plurality of fasteners, such that the embossing plate is between the bottom face of the first movable plate and the top face of the second movable plate,
wherein the conveyors are mounted to the longitudinal sides of the movable plates, each of the conveyors includes an endless chain and a first lug connected to the endless chain, and the endless chains of each of the pairs of conveyors are rotatable in a first direction to move the respective first lugs along corresponding rotational lug paths, and
wherein the embossing plate and the first fasteners are between, and do not extend into, the rotational lug paths.

20. The multi-opening press system of claim 19, wherein one or more of the conveyors further includes a second lug connected to the endless chain thereof and spaced apart from the respective first lug along the rotational lug path, such that as the first lug is moved along an upper portion of the rotational lug path toward a downstream end of the conveyor, the second lug is moved along a lower portion of the rotational lug path toward an upstream end of the conveyor.
